(19) United States
(12) Patent Application Publication
(10) Pub. No.: US 2009/0294728 A1
(43) Pub. Date: Dec. 3, 2009

(54) Composite Material Storing Hydrogen, and Device for the Reversible Storage of Hydrogen

(75) Inventors: Gagik Barkhordarian, Geesthacht (DE); Thomas Klassen, Wentorf (DE); Ruediger Bormann, Rosengarten (DE)

Correspondence Address: NORRIS, MCLAUGHLIN & MARCUS, P.A., 875 THIRD AVE, 18TH FLOOR, NEW YORK, NY, 10022, US

(73) Assignee: GKSS-FORSCHUNGSZENTRUM GEESTHACHT GMBH, Geesthacht (DE)

(21) Appl. No.: 11/721,493

(22) PCT Filed: Mar. 30, 2005
(86) PCT No.: PCT/EP2005/003494

§ 371 Date: Jun. 12, 2007

(30) Foreign Application Priority Data
Dec. 14, 2004 (DE) 102004061286.2

(51) Int. Cl. C01B 3/02

(52) U.S. Cl. 252/188.25

(57) ABSTRACT

The invention relates to a composite material storing hydrogen. Said composite material can alternate, in an essentially reversible manner, between a storage state and a non-storage state and optionally at least on intermediate state. In the storage state thereof, the system comprises the following constituents: (a) at least one first hydride constituent and (b) at least one second constituent that is at least one hydrogen-free constituent and/or one other hydride constituent. The at least one first hydride constituent and the at least one second constituent are in a first solid multiphase system, and during the changeover to the non-storage state of the system, the at least one first hydride constituent reacts with the at least one second constituent, forming H₂, in such a way that, in the non-storage state, at least one other hydrogen-free compound and/or alloy is formed and another solid multiphase system is created.

The invention relates to a composite material for storing hydrogen and an apparatus for reversible storage of hydrogen, in particular for supplying fuel cells.

Increasing contamination of the environment and diminishing fossil fuel reserves require new energy concepts. In particular, renewable energy sources are desirable to replace fossil fuels which due to their CO₂ emissions are blamed for the greenhouse effect and global warming. In this context, hydrogen has ideal properties. Hydrogen can be generated from water by electrolysis, whereby the electric energy is ideally obtained from renewable energy sources, such as wind power, solar energy or hydro power. Moreover, combustion of hydrogen, for example in internal combustion engines or fuel cells, produces only water vapor, representing a closed energy cycle without environmentally harmful emissions. In addition to stationary applications, hydrogen-based energy is also suitable for mobile applications in so-called zero-emission vehicles. However, storage of hydrogen (H₂) is problematic with both stationary and mobile applications due to its low boiling point (about 20 K or −253° C. at 1 bar) and its low density in the gaseous state at normal pressure (90 g/m³). Storage of liquid or gaseous H₂ also causes safety problems. For this reason, hydrogen storage systems are advantageous which store H₂ in chemical form, have excellent long-term stability and low H₂ pressures, and a volume-based energy density which is about 60% greater than that of liquid hydrogen. Chemical hydrogen storage devices have a storage state and a non-storage state (and possibly one or more intermediate states), between which the storage devices can ideally be reversibly transformed.

One known group of chemical hydrogen storage devices with a high specific hydrogen storage capacity are light metal hydrides of, for example, Mg, B or Al. For example, MgH₂ is theoretically able to store up to 7.6 wt. % H₂. Disadvantageously, these compounds have slow storage kinetics at room temperature, requiring several hours to “fill a tank.” Storage rates for MgH₂ are adequate only at temperatures above 300° C., and for this reason the light metal hydrides also referred to as high-temperature hydrides.

Also know are complex hydrides having the formula MₓA_{y}H_{z}, wherein M is an alkali or alkaline-earth metal and A is generally aluminum Al or boron B. These are capable of storing up to about 5 wt. % H₂ and are constituted in salt-like form from the cationic alkali or alkaline-earth metal (e.g., Na⁺ or Mg²⁺) and the anionic hydride group (e.g., AlH₄⁻ or BH₄⁻. The alkali alanates LiAlH₄ and NaAlH₄ are of particular interest due to their relatively large H₂ storage capacity per unit mass. Alanates decompose in two steps (e.g., 3 NaAlH₄→Na₃AlH₆+2Al+3H_{2→3}NaH+3Al+9/2H₂). However, re-hydrogenation requires diffusion and recombination of metal atoms which still results in relatively slow kinetics. Almost complete reversibility was demonstrated when using nano-crystalline alanates, with TiCl₃ added as a promoter. Sodium alanates then re-hydrogenate at temperatures of 100 to 150° C. within 10 minutes, however, requiring pressures of at least 80 bar.

On the other hand, so-called room temperature hydrides of transition metals are known (e.g., FeTiH_{z}, or LaNi₅H_{z}), which can be used at room temperature, but are only able to store at most 3 wt. % hydrogen.

More recently, attempts were made to investigate the use of nitrogen-containing groups, for example conversion of lithium amide to lithium imide, which would theoretically allow to store up to 9.1 wt. % hydrogen. However, because nitrogen can here be released in the form of NH₃, the system has only a limited reversibility. Significant improvements are achieved by adding Mg and forming magnesium nitride Mg₃N₃, whereby reversibility was observed at 200° C. and 50 bar.

US 2001/0018939 A describes a composition consisting of a homogeneous alloy made from an AlH₃-based complex hydride Mₓ(AlH₃)H_{z} (with M=Li, Na, Be, Mg, Ca) and a second component. The latter can be a non-hydride-forming metal or semi-metal or a hydride-forming alkaline earth or transition metal, or a binary metal hydride of those materials, or another AlH₃-based complex hydride. The material was analyzed by x-ray diffraction analysis and confirmed to be single phase. It has a H₂-storage capacity per unit mass of at most 3% and an absorption period of several hours at about 130° C. and 80 bar.

U.S. Pat. No. 6,514,478 B describes a system which includes in the hydrogenated state LiH or a lithium-based complex hydride LiₓM_{y}H_{z} with M=Be, Mg, Ti, V, Zr, with the addition of a metal or semi-metal. The system is single-phase in the hydrogenated state (storage state), for example as Li—C—H, whereby in the de-hydrogenated state addition of the elements forms a compound or solution with Li with a single phase (e.g., Li—C). For example, the system Li—C—H has a de-hydrogenation temperature of 150 to 230° C. and a hydrogenation temperature of 200° C. and a storage capacity of about 0.5 wt. %.

In summary, it can be stated that presently no system exists that is capable of highly reversibly storing hydrogen at intermediate or low temperatures with adequate speed and in large quantities. It is an object of the present invention to provide such a material, in particular a material with a high specific storage capacity and reversibility at low hydrogenation and de-hydrogenation temperatures.

This object is solved by the invention with a composite material having the features recited in claim 1. The composite material of the invention is substantially reversibly transformable between a storage state and a non-storage state (and optionally one or more intermediate states), wherein the system includes in its storage state the components:

(a) at least one first hydride component and
(b) at least one second component which may be at least a hydrogen-free component and/or an additional hydride component,
wherein the at least one first hydride component (a) and the at least one second component (b) are present in a first solid multi-phase system and wherein during transformation into the non-storage state of the system the at least one first hydride component (a) reacts with the at least one second component (b) (i.e., the hydrogen-free and/or the additional hydride component) in a redox reaction under formation of H₂ in such a way that in the non-storage state at least one additional hydrogen-free compound and/or alloy is formed and an additional solid multi-phase system is produced.

According to the invention, both the (hydrogenated) storage and the (de-hydrogenated) non-storage state of the composite material exist in at least two corresponding solid phases, wherein the material may have an amorphous or crystalline, preferably nano-crystalline, microstructure, or a mixture thereof. In the context of the present invention, the term “phase” refers to a defined (crystal) structure (as opposed to an aggregation state), i.e., in a solid “multi-phase system” according to the invention there exist two or more structures which can be differentiated by x-ray diffraction analysis, each of which can be crystalline or amorphous. Moreover, the term “hydrogen-free” component, compound or alloy shall refer to a phase which is not present as hydride. However, this does not imply that the “hydrogen-free” phase may not still include small amounts of dissolved hydrogen, in particular near lattice defects. The term “non-storage state” is to be understood as a state which, as opposed to the “storage state”, is hydrogen-depleted, but is not necessarily entirely free of hydrogen.

In other words, in both states there always exist at least two phases which can be traced to the individual components. This means that nanocrystals of the first hydride component (a) and nanocrystals of the second component (b) coexist in the preferred, substantially nano-crystalline microstructure of the system. It has been observed that the system of the invention advantageously provides, on one hand, easier re-hydrogenation (hydrogen absorption) and therefore improved reversibility as compared to single-phase systems and, on the other hand, a lower de-hydrogenation temperature. Moreover, although the thermodynamic driving force of the hydrogenation reaction, for example, in a conventional system (e.g., LiBH₄→LiH+B+3/2H₂) is greater than in a multi-phase system of the invention (e.g., 2LiBH₄+MgH₂←→2LiH+MgB₂+4H₂), measurements have shown easy hydrogenability and hence good reversibility only for the system according to the invention. This is presumably due to a kinetic effect, in particular the pronounced tendency of elementary boron to diffuse, which may cause macroscopic de-mixing of the components, thereby frustrating the reaction of B with LiH under formation of LiBH₄ in the conventional system. Conversely, the spatial distribution of MgB₂ in the mixture and the electronic distribution of boron in MgB₂ in the system of the invention appear to promote the hydrogenation reaction.

Another advantage is the less negative reaction enthalpy, i.e., the higher thermodynamic driving force in the de-hydrogenation reaction at a given temperature which is caused by the more advantageous electronic distribution of the hydrogen-free compound (e.g., MgB₂ as opposed to B in the aforementioned example) in the non-storage state. Most preferably, the components in both the non-storage and the storage state and/or the microstructure of the material can be selected so that so that the reaction enthalpy of the complete redox reaction of the system between its non-storage state and its storage state per mole hydrogen H₂ is in a range between −10 to −65 kJ/mole_{H2}, in particular −15 to −40 kJ/mole_{H2}. The de-hydrogenation temperatures (desorption temperatures) can then be set in a range between typically 20 and 180° C. These temperatures can be further reduced by adding one or more suitable catalysts.

By and large, the hydrogenation reaction of the material of the invention appears to be improved over conventional single-phase systems due to kinetic effects and the de-hydrogenation reaction due to thermodynamic effects, so that the material is distinguished, on one hand, by a high reversibility and, on the other hand, by a low desorption temperature.

The material of the invention can be transformed between its storage state and its non-storage state (and its optional intermediate states) by varying the pressure and/or the temperature.

The material can be readily prepared from the components of the storage state and can be subjected to one or more de-hydrogenation and hydrogenation cycles before use. Alternatively, the components of the non-storage state can be processed together and subsequently hydrogenated. Mixed forms, wherein components are used that are made in part of the hydrogenated and in part of the de-hydrogenated state or of intermediate states or of precursor structures, are also feasible. For example, an elemental metal E can be used for the preparation, which after hydrogenation forms the binary hydride EₓH_{z}.

According to an advantageous embodiment of the invention, the composite material has in the storage state the following components:

(a) at least one first hydride component which includes
(i) at least one complex hydride MₓA_{y}H_{z}, wherein A is at least one element selected from the groups IIIA, IVA, VA, VIA and IIB of the periodic table, and M is a metal with an atomic number ≧3, selected from the groups IA, IIA, IIIB, and the lanthanides, and/or
(ii) at least a first binary hydride BₓH_{z}, wherein B is selected from the groups IA, IIA, IIIB, IVB, VB, XB and XIIB and the lanthanides, and
(b) at least one second component which includes one or more components from
(i) an element C in the oxidation stage 0,
(ii) a hydrogen-free, binary or higher compound or alloy of the element C with at least one additional element D,
(iii) a second binary hydride EₓH_{z}, wherein E is selected from the groups IA, IIA, IIB, IIIB, IVB, VB, XB and XIIB and the lanthanides, and
(iv) an alloy hydride FₓG_{y}H_{z} of at least two metals F and G.

According to the invention, in the aforementioned system the elements C, D, E, F and/or G of the component (b) in the non-storage state are present in at least one hydrogen-free compound and/or alloy with at least one of the elements A, B and/or M of the component (a).

The invention is here not limited to a small number of suitable components. Instead, a large variety of complex or binary hydrides, elements and hydrogen-free compounds and allies can be employed, as long as the components react with one another in the required manner and the entire reaction between storage and non-storage state has a suitable reaction enthalpy.

In a particularly preferred embodiment, the hybrid component (a) is a complex hydride.

Within the aforedescribed context, the elements C and D can be selected from the group of the metals, non-metals, semi-metals and transition metals and the lanthanides. In particular from the group Sb, Bi, Ge, Sn, Pb, Ga, In, Tl, Se, S, Te, Br, I, Sc, Y, La, Ti, Zr, Hf, V, Nb, Ta, Mo, W, Re, Ru, Os, Co, Ag, Li, Rb, Cs, Be, Mg, Sr, Ba, and the lanthanides Ce, Pr, Nd, Pm, Sm, Eu, Gd, Tb, Dy, Ho, Er, Tm, Yb, and Lu.

The elements B and E of the binary hydrides are selected, in particular, from the group Li, Na, K, Rb, Cs, Be, Mg, Ca, Sr, Sc, Y, La, Ti, Zr, Hf, V, Nb, Ta, Zn, Pd, and the lanthanides Pr, Nd, Pm, Sm, Eu, Gd, Tb, Dy, Ho, Er, Tm, Yb, and Lu.

In addition, the metal M of the complex hydride MₓA_{y}H_{z} is preferably selected from the group Li, Na, K, Rb, Cs, Be, Mg, Ca, Sc, Y, and La, and A is one element or several different elements selected from the group B, Al, Ga, C, Si, Ge, Sn, N and Zn, in particular B and Al.

In the following, several more specifically preferred families of composite materials according to the invention will be described.

A first family is particularly directed to lithium-free and aluminum-free hydrides, wherein the at least one first hydride component (a) is a complex hydride MₓA_{y}H_{z}, wherein the metal M has an atomic number >3, and the element A is selected from the group B, Si, C, Ga, Ge, and N. This component can be combined with all of the aforementioned components (b). The complex hydride can more particularly be a boron hydrate, e.g., NaBH₄, Ca(BH₄)₂, Mg(BH₄)₂, La(BH₄)₃, or Y(BH₄)₃.

Preferred examples of the composite materials of the first family will now be described. For several examples, the reaction enthalpy ΔH, the reaction entropy ΔS and the free reaction enthalpy ΔG (298 K) at 25° C. according to the equation ΔG=ΔH−T ΔS are listed together with the equilibrium temperature T_{eq}, at which the hydride is in equilibrium with 1 bar hydrogen gas, i.e., ΔG⁰ is equal to 0. At temperatures above T_{eq} (or for example at a lower pressure) the contribution from the entropy dominates and the hydride decomposes, whereas at a temperature below T_{eq} (or for example at a lower pressure) the chemical enthalpy dominates and the hydride is formed. The listed values for ΔH and ΔS preferred to the corresponding reaction equation given below.

2NaBH₄+Mg [symbol] MgB_{Z}+2NaH+3H₂

ΔG=103.000 J/mol−(T×231 J/(mol·K))

[symbol]

T_{eq.}=172° C., ΔH_{H2}=34.3 kJ/mol

3NaBH₄+As [symbol] Na₃As+3B+6H₂

ΔG=365.000 J/mol−(T×590 J/(mol·K))

[symbol]

T_{eq.}=345° C.; ΔH_{H2}=60.8 kJ/mol

3NaBH₄+AlSb [symbol] Na₃Sb+AlB₃+B+6H₂

ΔG=277.000 J/mol−(T×658 J/(mol·K))

[symbol]

T_{eq.}=150° C.; ΔH_{H2}=46.2 kJ/mol

NaBH₄+Se [symbol] NazSe+2B+4H₂

2NaBH₄+MgH₂ [symbol] MgB₂+2NaH+4H₂

Ca(BH₄)₂+Mg+MgH₂ [symbol] MgB₂+CaH₂+3H₂

La(BH₄)₃+1.5MgH₂ [symbol] 1.5MgB₂+LaG₃+6H₂

Mg(BH₄)₂+MgH₂ [symbol] MgB₂+MgH₂+4H₂

Y(BH₄)₃+1.5MgH₂ [symbol] 1.5MgB₂+YH₃+6H₂

A second family is directed particularly to lithium-based (aluminum-free) hydrides, wherein

(a) the at least one first hydride component includes a complex lithium hydride LiₓA_{y}H_{z}, wherein A is at least one element selected from the group B, Si, C, Ga, Ge, Zn, Sn, S and N, and
(b) the at least one second component includes one or more components of
b1) at least one element C1, selected from the group C, B, Si, P, Zn, Mn, Fe, Cr, Cu, Al, N, wherein LiH (and a compound or alloy of Cl and A) is formed in the non-storage state,
b2) at least one element C2, selected from the group Sb, Bi, Ge, Sn, Pb, Ga, Tl, Se, S, Te, Br, I, In, As, Mo, W, Co, Ni, Cd, Hg, N, (wherein in the non-storage state a compound or alloy of C2 with Li or of C2 with A is formed),
b3) at least one hydrogen-free compound or alloy of two or more elements C and D with an atomic number >3, of which preferably at least one is selected from the aforementioned groups for C1 and C2, (wherein in the non-storage state Li forms a compound or alloy with at least one of the elements),
b4) at least one binary metal hydride EₓH_{z}, (wherein in the non-storage state a compound of E with Li and/or A is formed), and
b5) at least one alloy hydride FₓG_{y}H_{z} of at least two metals F and G, (wherein in the non-storage state a compound of F and/or G with Li and/or A is formed)

Optionally, the second component (b) can also be a combination of two or more components from the group b1 to b5.

Preferred examples for composite materials of the second family are:

2LiBH₄+Cr [symbol] 2LiH+CrB₂+3H₂

ΔG₂₉₈=86.000 J/mol−(T×295 J/(mol·K))

[symbol]

T_{eq.}=18° C.; ΔH_{H3}=28.7 kJ/mol

2LiBH₄+MgH₂ [symbol] MgB₂+2LiH+3H₂

ΔG=183.000 J/mol−(T×413(J/mol·K))

[symbol]

T_{eq.}=170° C.; ΔH_{H2}=61.0 kJ/mol

2LiBH₄+MgS [symbol] Li₂S+MgB₂+4H₂

ΔG=166.000 J/mol−(T×417(J/mol·K))

[symbol]

T_{eq.}=125° C.; ΔH_{H2}=41.5 kJ/mol

8LiBH₄+2Mg₂Sn [symbol] Li₇Sn₂4MgB₂+15.5H₂+LiH

ΔG=758.000 J/mol−(T×1679 J/(mol·K))

[symbol]

T_{eq.}=178° C.; ΔH_{H2}=48.9 kJ/mol

6LiBH₄+Se₃Al₂ [symbol] 3Li₂Se+6B+2Al+12H₂

ΔG=446.000 J/mol−(T×1246 J/(mol·K))

[symbol]

T_{eq.}=84° C.; ΔH_{H2}=37.2 kJ/mol

4LiBH₄+C [symbol] B₄C+4LiH+6H₂

ΔG=329.000 J/mol−(T×579 J/(mol·K))

[symbol]

T_{eq.}=295° C.; ΔH_{H2}=54.8 kJ/mol

2LiBH₄+Se [symbol] Li₂Se+2B+4H₂

2LiBH₄⁺Te [symbol] Li₂Te+2B+4H₂

A third family is directed more particularly to an aluminum-based (lithium-free hydrides, wherein

(a) the at least one first hydride component comprises a complex aluminum hydride MₓAl_{y}H_{z}, wherein M is a metal having an atomic number >3, and
(b) the at least one second component comprises one or more components of
b1) at least one element C selected from the group Na, K, Sr, Hf. Nb, Ta and the lanthanides,
b2) at least one hydrogen-free compound or alloy of two or more elements C and D, wherein C is selected in particular from the group Be, Mg, Ca, Ti, V, Y, Zr and La, and D is in particular an element with an atomic number >3,
b3) at least one binary metal hydride EₓH_{z}, and
b4) at least one alloy hydride FₓG_{y}H_{z} of at least two metals F and G.

Optionally, the component (b) can also be a combination of two or more components from the group b1 to b4.

Preferred examples for composite materials of the third family are:

2NaAlH₄+Se [symbol] Na₂Se+2Al+4H₂

3NaAlH₄+Nb [symbol] NbAl₃+3NaH+4.5H₂

3KAlH₄+Nb [symbol] NbAl₃+2KH+4.5H₂

A fourth family is directed more particularly to aluminum-based and lithium-based hydrides, wherein

(a) the at least one first hydride component is a complex lithium aluminum hydride LiₓAl_{y}H_{z}, preferably LiAlH₄, and
(b) the at least one second component includes one or more components of
b1) at least two elements C1 and D1 in the oxidation stage 0 and/or at least one hydrogen-free solid compound of at least two elements C1 and D1, wherein C1 and D1 are selected from the group N, Ga, In, Ge, Sn, Pb, As, Sb, S, Se, Te,
b2) at least two elements C1 and D1 in the oxidation stage 0 and/or at least one hydrogen-free solid compound of at least two elements C1 and D1, wherein C2 and D2 are selected from the group C, B, Si, P, Zn, Mn, Fe, Cu, Cr, Al, N, wherein LiH is formed in the non-storage state,
b3) at least one hydrogen-free compound or alloy of a hydride-forming metal C with at least one element D having an atomic number >3, wherein in the non-storage state Li forms at least one compound with the element C and/or D,
b4) at least one binary metal hydride EₓH_{z}, and
b5) at least one alloy hydride FₓG_{y}H_{z} of at least two metals F and G.

Optionally, the component (b) can also be a combination of two or more components from the group b1 to b5.

Preferred examples for composite materials of the fourth family are:

3LiAlH₄⁺Nb [symbol] NbAl₃+3LiH+4.5H₂

2LiAlH₄+Se [symbol] Li₂Se+2Al+4H₂

2LiAlH₄+Te [symbol] Li₂Te+2Al+4H₂

2LiAlH₄+As [symbol] Li₂As+2Al+4H₂

A further aspect of the invention relates to a system for reversible storage of hydrogen H₂, in particular for supplying a fuel cell in mobile or stationary applications, wherein the device includes at least one composite material capable of storing hydrogen according to the above description. A catalyst which supports the initial dissociation of H₂ into 2H during the hydrogenation process of the material can also be added to the material. A large number of such catalysts are known in the art.

Additional advantageous embodiments of the invention are recited as features of the dependent claims.

An exemplary embodiment of the invention will now be described with reference to the appended drawings which show in:

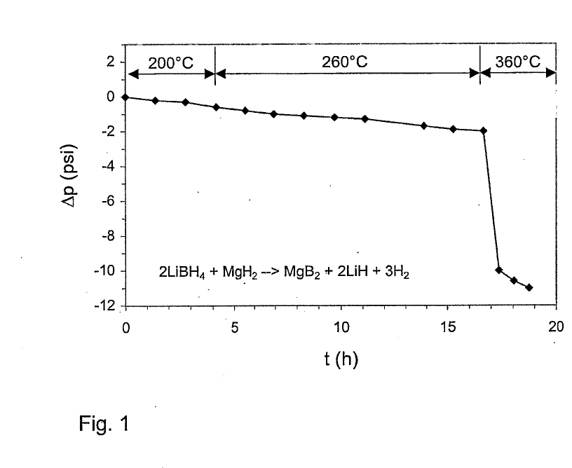

FIG. 1 a desorption characteristic of the material LiBH₄/MgH₂ at different temperatures;

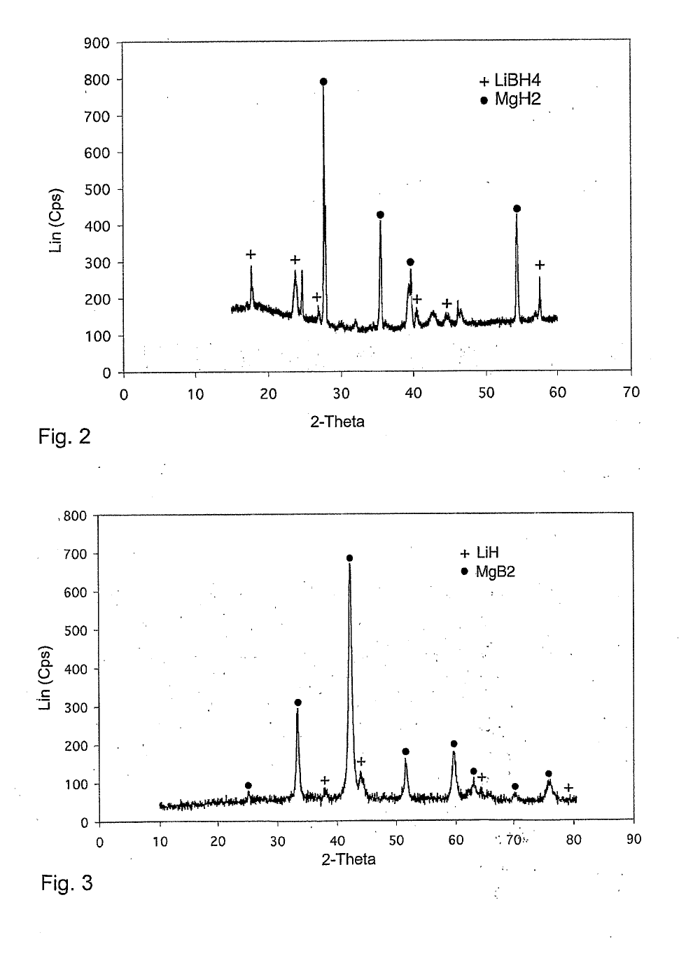

FIGS. 2, 3 x-ray diffraction patterns of the material LiBH₄/MgH₂ after hydrogenation (storage state) and after de-hydrogenation (non-storage state), respectively;

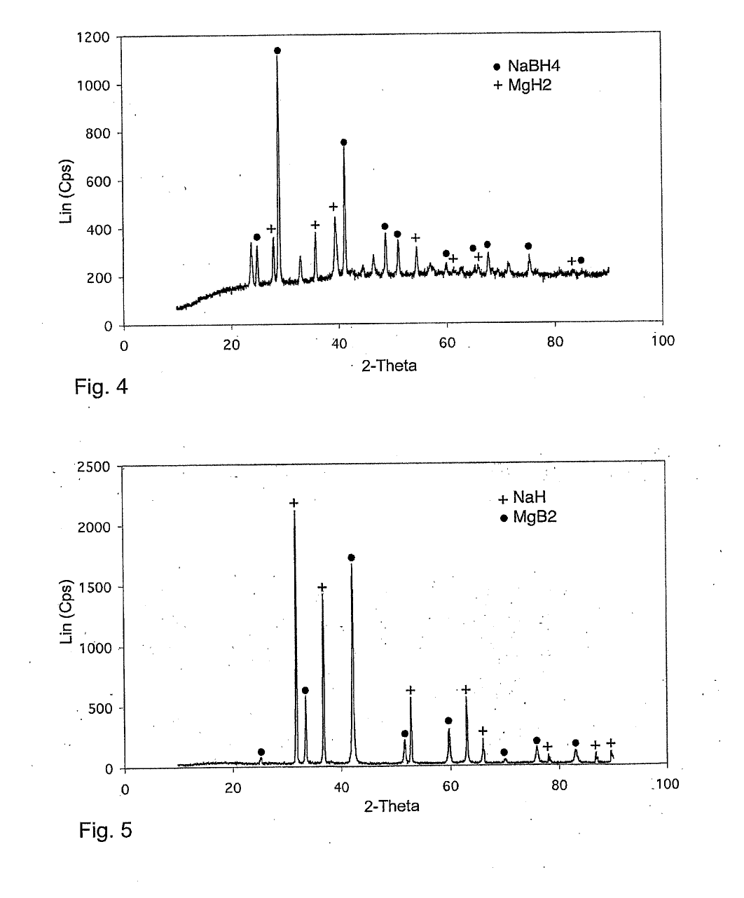

FIGS. 4, 5 x-ray diffraction patterns of the material NaBH₄/MgH₂ in the storage state and the non-storage state, respectively;

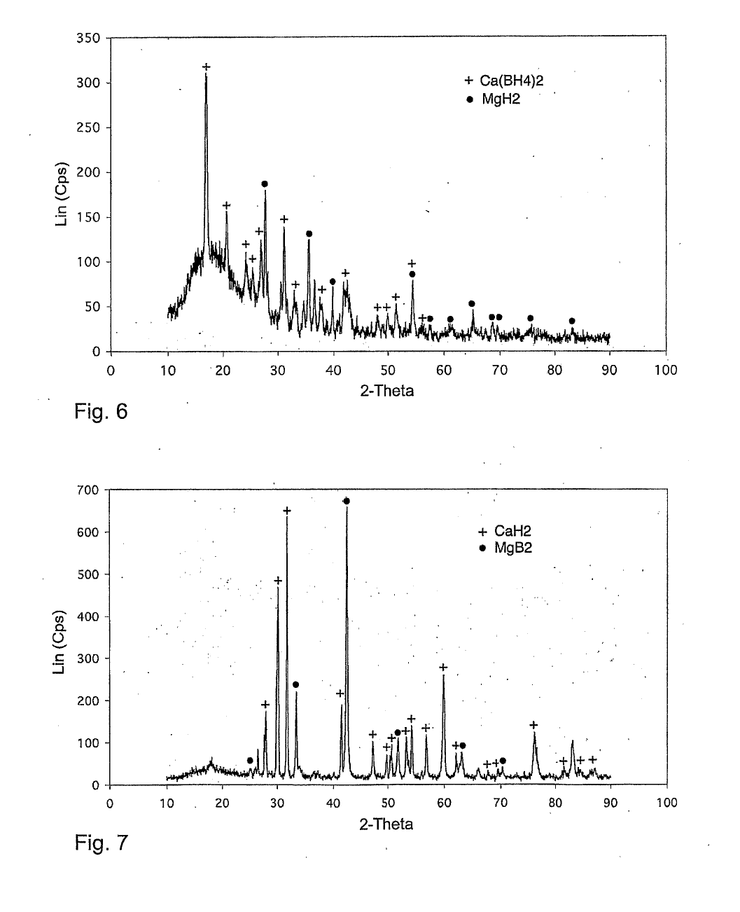

FIGS. 6, 7 x-ray diffraction patterns of the material Ca(BH₄)₂/MgH₂ in the storage state and the non-storage state, respectively;

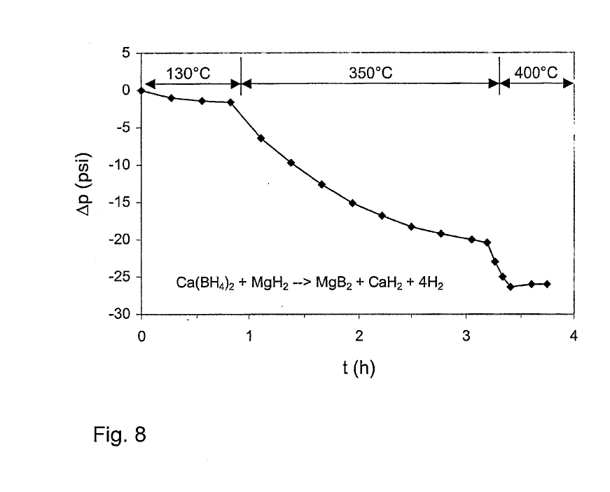

FIG. 8 a desorption characteristic of the material Ca(BH₄)₂/MgH₂ at various temperatures; and

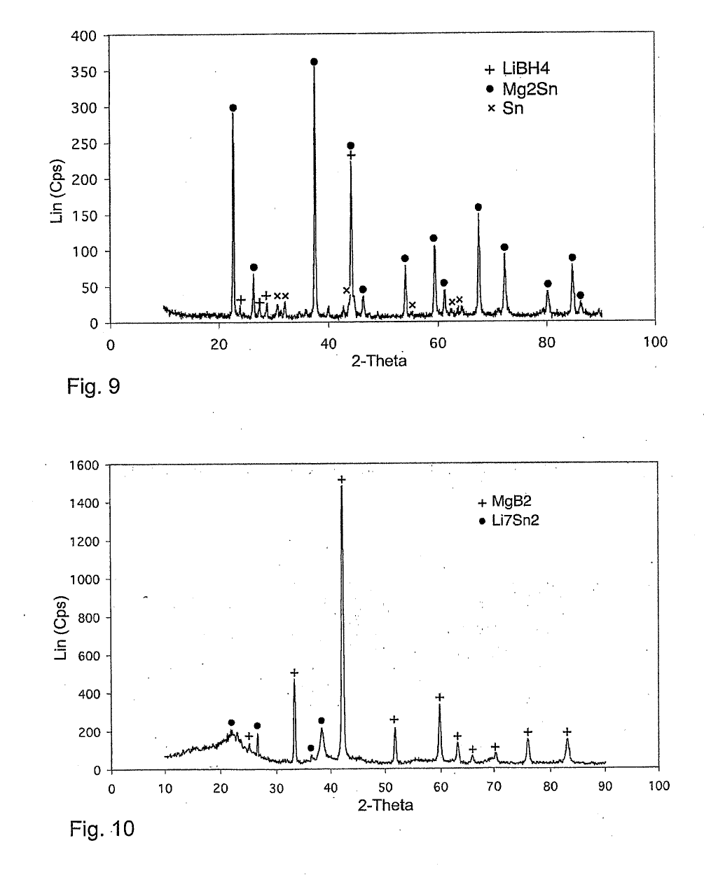

FIGS. 9, 10 x-ray diffraction patterns of the material LiBH₄/Mg₂Sn in the storage state and the non-storage state, respectively.

### 1. PREPARATION OF THE MATERIAL LiBH₄/MgH₂

The starting materials LiH and MgB₂ were mixed in a mole ratio of 2:1 and milled for 24 hours in a mill of the type SPEX 8000.1 g of the obtained nano-crystalline powder was mixed in a high-pressure vessel at 300 bar hydrogen pressure and a temperature of 400° C. for 24 hours (2LiH+MgB₂+3H₂→2LiBH₄+MgH₂). A mass increase of 12% was observed.

The absorption and desorption characteristics of the produced composite material were investigated by exposing the material in a closed vessel to different temperatures and measuring the pressure change in the vessel. As seen in FIG. 1, release of hydrogen (de-hydrogenation) was already observed at the starting temperature of 200° C., and this reaction accelerated at higher temperatures. At a temperature of about 360° C., a very fast and practically complete transformation into the non-storage state occurs. By using a suitable catalyst, the de-hydrogenation can be accelerated, producing sufficiently fast kinetics at significantly lower temperatures. Such catalysts are generally known and will therefore not to be described in detail. A specific hydrogen storage capacity of 10 wt. % with reference to the material before hydrogenation, i.e., its non-storage state, was inferred from the weight difference of the material before and after hydrogen absorption.

In addition, x-ray diffraction analysis was performed on the material before and after hydrogen desorption, i.e., in its storage and non-storage state, respectively (FIGS. 2 and 3). According to FIG. 2, all diffraction lines of the hydrogenated storage state could be associated with the crystal structures of LiBH₄ and MgH₂. Conversely, the diffraction lines in FIG. 3 can be unambiguously associated with the components LiH and MgB₂ of the de-hydrogenated non-storage state. This confirms the two-phase state of the system in both its storage and its non-storage state.

### 2. PREPARATION OF THE MATERIAL NaBH₄/MgH₂

The material was prepared in analogy to example 1. The relevant preparation parameters and material properties are summarized below in table form.

### Preparation Reaction:

### MgB₂+2NaH+4H₂→2NaBH₄+MgH₂

Calculated equilibrium temperature T_{eq}: 170° C.
Starting materials: NaH, MgB₂ (mole ratio 2:1)
Milling time: 10 hours
Hydrogenation pressure: 300 bar
Hydrogenation temperature: 200° C.
Hydrogenation duration: 12 hours
Reversible hydrogen content: 8 wt. %
Stoichiometric hydrogen content in NaBH₄: 10.5 wt. %

As seen in FIG. 4 which shows the x-ray diffraction pattern of the material NaBH₄/MgH₂ following hydrogenation, all diffraction lines could be unambiguously associated with the components MgH₂ and NaBH₄ of the storage state. Conversely, the diffraction lines visible in FIG. 5 and measured after de-hydrogenation could be associated with the components MgB₂ and NaH of the non-storage state.

### 3. PREPARATION OF THE MATERIAL Ca(BH₄)₂/MgH₂

The material was prepared in analogy to example 1. The relevant preparation parameters and material properties are summarized below in table form.

### Preparation Reaction:

### MgB₂+CaH₂+4H₂→Ca(BH₄)₂+MgH₂

Calculated equilibrium temperature T_{eq}: 120-150° C.
Starting materials: CaH₂, MgB₂ (mole ratio 1:1)
Milling time: 6 hours
Hydrogenation pressure: 300 bar
Hydrogenation temperature: 200° C.
Hydrogenation duration: 6 hours
Reversible hydrogen content: 8.3 wt. %
Stoichiometric hydrogen content in Ca(BH₄)₂: 11.5 wt. %

As seen in FIG. 6 which shows the x-ray diffraction pattern of the material Ca(BH₄)₂/MgH₂ following hydrogenation, all diffraction lines could be associated unambiguously with the components MgH₂ and Ca(BH₄)₂ of the storage state. Conversely, the diffraction lines visible in FIG. 7 measured after de-hydrogenation could be associated with the components MgB₂ and CaH₂ of the non-storage state.

The desorption characteristic of the material Ca(BH₄)₂/MgH₂ was measured analogous to the procedure described with reference to Example 1 at temperatures of 130, 350 and 400° C. and is shown in FIG. 8. The change in pressure corresponds to a release of 8.3 wt. % (reversible hydrogen content) with reference to the storage state.

### 4. PREPARATION OF THE MATERIAL LiBH₄/Mg₂Sn/Sn

The material was prepared in analogy to example 1. The relevant preparation parameters and material properties are summarized below in table form.

### Preparation Reaction:

### Li₇Sn₂+3.5MgB₂+14H₂→7LiBH₄+1.75Mg₂Sn+0.25Sn

Calculated equilibrium temperature T_{eq}: 175° C.

### ΔG=684,000 J/mole−(T×1535 J/(mole*K))

Starting materials: Li₇Sn₂, MgB₂ (mole ratio 1:3.5)
Milling time: 12 hours
Hydrogenation pressure: 300 bar
Hydrogenation temperature: 300° C.
Hydrogenation duration: 6 hours
Reversible hydrogen content: 6 wt. %
Stoichiometric hydrogen content in LiBH₄: 18.5 wt. %

As seen in FIG. 9 which shows the x-ray diffraction pattern of the material LiBH₄/Mg₂Sn/Sn following hydrogenation, all diffraction lines could be unambiguously associated with the components Mg₂Sn, LiBH₄, and Sn of the storage state. Conversely, the diffraction lines visible in FIG. 10 measured after de-hydrogenation could be associated with the components Li₇Sn₂ and MgB₂ of the non-storage state.

All hydrogenation conditions for the preparation of the materials (pressure, temperature, duration) mentioned above were not optimized. They were selected instead to achieve the highest possible hydrogenation rate.

1. Composite material for storing hydrogen, said material being substantially reversible between a storage state and a non-storage state and optionally transformable into one or more intermediate states, wherein the system comprises in its storage state the components:
(a) at least one first hydride component and
(b) at least one second component which is at least a hydrogen-free component and/or an additional hydride component,
wherein the at least one first hydride component and the at least one second component are present in a first solid multi-phase system and wherein in the transformation into the non-storage state of the system the at least one first hydride component reacts with the at least one second component under formation of H₂ in such a way that in the non-storage state at least one additional hydrogen-free compound and/or alloy is formed and an additional solid multi-phase system is produced.

2. Composite material according to claim 1, wherein the material comprises an amorphous or crystalline, in particular nano-crystalline, microstructure, or a mixture thereof.

3. Composite material according to claim 1, wherein in the storage state
(a) the at least one first hydride component comprises
(i) at least one complex hydride MₓA_{y}H_{z}, wherein A is at least one element selected from the groups IIIA, IVA, VA, VIA and IIB of the periodic table, and M is a metal with an atomic number ≧3, selected from the groups IA, IIA, IIIB, IVB, VB and the lanthanides, and/or
(ii) at least a first binary hydride BₓH_{z}, wherein B is selected from the groups IA, IIA, IIIB, IVB, VB, XB and XIIB and the lanthanides, and
(b) the at least one second component comprises one or more components from
(i) an element C in the oxidation stage 0,
(ii) a hydrogen-free, binary or higher compound or alloy of the element C with at least one additional element D,
(iii) a second binary hydride EₓH_{z}, wherein E is selected from the groups IA, IIA, IIB, IIIB, IVB, VB, XB and XIIB and the lanthanides, and
(iv) an alloy hydride FₓG_{y}H_{z} of at least two metals F and G.

4. Composite material according to claim 3, wherein the elements C and D are selected from the group of the metals, non-metals, semi-metals and transition metals and the lanthanides, in particular from the group Sb, Bi, Ge, Sn, Pb, Ga, In, Tl, Se, S, Te, Br, I, Sc, Y, La, Ti, Zr, Hf, V, Nb, Ta, Mo, W, Re, Ru, Os, Co, Ag, Li, Rb, Cs, Be, Mg, Sr, Ba, and the lanthanides.

5. Composite material according to claim 3, wherein the elements B and E of the binary hydrides are selected from the group Li, Na, K, Rb, Cs, Be, Mg, Ca, Sr, Sc, Y, La, Ti, Zr, Hf, V, Nb, Ta, Zn, Pd, and the lanthanides.

6. Composite material according to claim 3, wherein the metal M of the at least one complex hydride MₓA_{y}H_{z} is selected from the group Li, Na, K, Rb, Cs, Be, Mg, Ca, Sc, Y, La, Ti, Zr and Hf, and A is at least one element selected from the group B, Al, Ga, C, Si, Ge, Sn, N and Zn, in particular B and Al.

7. Composite material according to claim 3, wherein the at least one first hydride component is a complex hydride MₓA_{y}H_{z}, wherein the metal M has an atomic number >3, and the element A is selected from the group B, Si, C, Ga, Ge, Zn, Sn, S and N.

8. Composite material according to claim 3, wherein
(a) the at least one first hydride component comprises a complex lithium hydride LiₓA_{y}H_{z}, wherein A is at least one element selected from the group B, Si, C, Ga, Ge, Zn, Sn, S and N, and
(b) the at least one second component comprises one or more components of
b1) at least one element C1, selected from the group C, B, Si, P, Zn, Mn, Fe, Cr, Cu, Al, N, wherein LiH is formed in the non-storage state,
b2) at least one element C2, selected from the group Sb, Bi, Ge, Sn, Pb, Ga, Tl, Se, S, Te, Br, I, In, As, Mo, W, Co, Ni, Cd, Hg, N,
b3) at least one hydrogen-free compound or alloy of two or more elements C and D with an atomic number >3,
b4) at least one binary metal hydride EₓH_{z}, and
b5) at least one alloy hydride FₓG_{y}H_{z} of at least two metals F and G.

9. Composite material according to claim 3, wherein
(a) the at least one first hydride component comprises a complex aluminum hydride MₓAl_{y}H_{z}, wherein M is a metal having an atomic number >3, and
(b) the at least one second component comprises one or more components of
b1) at least one element C selected from the group Na, K, Sr, Hf. Nb, Ta and the lanthanides,
b2) at least one hydrogen-free compound or alloy of two or more elements C and D, wherein C is selected in particular from the group Be, Mg, Ca, Ti, V, Y, Zr and La, and D is in particular an element with an atomic number >3,
b3) at least one binary metal hydride EₓH_{z}, and
b4) at least one alloy hydride FₓG_{y}H_{z} of at least two metals F and G.

10. Composite material according to claim 3, wherein
(a) the at least one first hydride component is a complex lithium aluminum hydride LiₓAl_{y}H_{z}, in particular LiAlH₄, and
(b) the at least one second component comprises one or more components of
b1) at least two elements C1 and D1 in the oxidation stage 0 and/or at least one hydrogen-free solid compound of at least two elements C1 and D1,
wherein C1 and D1 are selected from the group N, Ga, In, Ge, Sn, Pb, As, Sb, S, Se, Te,
b2) at least two elements C1 and D1 in the oxidation stage 0 and/or at least one hydrogen-free solid compound of at least two elements C1 and D1,
wherein C2 and D2 are selected from the group C, B, Si, P, Zn, Mn, Fe, Cu, Cr, Al, N, wherein LiH is formed in the non-storage state,
b3) at least one hydrogen-free compound or alloy of a hydride-forming metal C with at least one element D having an atomic number >3, wherein in the non-storage state Li forms at least one compound with the element C and/or D,
b4) at least one binary metal hydride EₓH_{z}, and
b5) at least one alloy hydride FₓG_{y}H_{z} of at least two metals F and G.

11. Composite material according to claim 1, wherein the components and the microstructure of the material are selected so that the reaction enthalpy (ΔH) of the complete reaction of the system between its non-storage state and its storage state per mole hydrogen H₂ is in a range between −10 to −65 kJ/mole_{H2}, in particular −15 to −40 kJ/mole_{H2}.

12. Composite material according to claim 1, wherein the material can be transformed between its storage state and its non-storage state and optionally its intermediate state(s) by varying pressure and/or temperature.

13. An apparatus for reversibly storing hydrogen (H₂), in particular for supplying a fuel cell or an internal combustion engine, comprising at least one composite material for storing hydrogen according to claim 1.
